(19) United States
(12) Patent Application Publication
(10) Pub. No.: US 2015/0156264 A1
(43) Pub. Date: Jun. 4, 2015

(54) FILE ACCESS OPTIMIZATION USING STRATEGICALLY PARTITIONED AND POSITIONED DATA IN CONJUNCTION WITH A COLLABORATIVE PEER TRANSFER SYSTEM

(71) Applicant: International Business Machines Corporation, Armonk, NY (US)

(72) Inventors: Gary D. Cudak, Creedmoor, NC (US); Lydia M. Do, Raleigh, NC (US); Christopher J. Hardee, Raleigh, NC (US); Adam Roberts, Moncure, NC (US)

(73) Assignee: International Business Machines Corporation, Armonk, NY (US)

(21) Appl. No.: 14/096,107

(22) Filed: Dec. 4, 2013

(51) Int. Cl. H04L 29/08; G06F 17/30

(52) U.S. Cl. CPC H04L 67/1097; G06F 17/30197

(57) ABSTRACT

A processor-implemented method for optimizing a file transfer is provided. The method may include receiving at least one file transfer request associated with a file. The method may further include acquiring, for the at least one file transfer request, a plurality of service level objectives associated with the file. The method may also include distributing a plurality of file segments associated with the file to at least one storage component associated with a shared storage infrastructure, wherein the distributing is based on a determining of at least one resource capability associated with the at least one storage component. Additionally, the method may include directing a complete transfer of the plurality of file segments associated with the file from the at least one storage component based on a file request for the file.

### FIELD OF THE INVENTION

The present invention relates generally to the field of computing, and more particularly to file storage and transfers.

### BACKGROUND

A storage system may also be known as a storage array, a disk array or a filer. A storage system typically uses special hardware and software along with disk drives in order to provide reliable storage for computing and data processing. Network-attached storage (NAS) is file-level computer data storage connected to a computer network providing data access to a heterogeneous group of clients. NAS provides both storage and a file system.

However, as files are increasing in size, it is taking longer than desired to transfer the large files over a network. As such, it is getting more difficult to increase file access on storage controllers and caching systems since specific applications or systems may have varying quality of service (QoS) requirements regarding the access of data on the storage systems. For example, a system's available bandwidth may exceed that of a particular controller's bandwidth when that particular controller is being accessed via multiple network devices.

### SUMMARY

A processor-implemented method for optimizing a file transfer is provided. The method may include receiving at least one file transfer request associated with a file. The method may further include acquiring, for the at least one file transfer request, a plurality of service level objectives associated with the file. The method may also include distributing a plurality of file segments associated with the file to at least one storage component associated with a shared storage infrastructure, wherein the distributing is based on a determining of at least one resource capability associated with the at least one storage component. Additionally, the method may include directing a complete transfer of the plurality of file segments associated with the file from the at least one storage component based on a file request for the file.

A computer system for optimizing a file transfer is provided. The computer system may include one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method. The method may include receiving at least one file transfer request associated with a file. The method may further include acquiring, for the at least one file transfer request, a plurality of service level objectives associated with the file. The method may also include distributing a plurality of file segments associated with the file to at least one storage component associated with a shared storage infrastructure, wherein the distributing is based on a determining of at least one resource capability associated with the at least one storage component. Additionally, the method may include directing a complete transfer of the plurality of file segments associated with the file from the at least one storage component based on a file request for the file.

A computer program product for optimizing a file transfer is provided. The computer program product may include one or more computer-readable storage devices and program instructions stored on at least one of the one or more tangible storage devices, the program instructions executable by a processor. The computer program product may include program instructions to receive at least one file transfer request associated with a file. The computer program product may also include program instructions to acquire, for the at least one file transfer request, a plurality of service level objectives associated with the file. The computer program product may further include program instructions to distribute a plurality of file segments associated with the file to at least one storage component associated with a shared storage infrastructure, wherein the distributing is based on a determining of at least one resource capability associated with the at least one storage component. Additionally, the computer program product may include program instructions to direct a complete transfer of the plurality of file segments associated with the file from the at least one storage component based on a file request for the file.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a block diagram which illustrates a networked computer environment according to at least one embodiment;

FIG. 2 is a block diagram which illustrates a networked computer environment with an exemplary file access optimization program and a tracker-updates client according to at least one embodiment;

FIG. 3 is a block diagram which illustrates a networked computer environment with an exemplary file access optimization program according to at least one embodiment;

FIG. 4 is a block diagram which illustrates a networked computer environment where a file may be evenly divided and distributed to storage controllers according to at least one embodiment;

FIG. 5 is a block diagram which illustrates a networked computer environment where a file may be disproportionately divided and distributed to storage controllers based on the capabilities of the storage controllers according to at least one embodiment;

FIG. 6 is a block diagram which illustrates a networked computer environment where a file may be disproportionately divided and distributed to storage controllers based on the hops of the storage controllers according to at least one embodiment;

FIG. 7 is a block diagram which illustrates a server with an exemplary tracker-updates client according to at least one embodiment;

FIG. 8 is a block diagram which illustrates a networked computer environment where the stored portions of a divided file may be retrieved and reconstructed from the storage controllers according to at least one embodiment;

FIG. 9 is an operational flowchart illustrating the steps carried out by a file access optimization program according to at least one embodiment; and

FIG. 10 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computing, and more particularly to file storage and transfers. The following described exemplary embodiments provide a system, method and program product to accelerate the transfer and access of files by intelligently and strategically dividing and storing files across a number of storage controllers (i.e., controllers) in a network-attached storage (NAS) environment, dependant on factors relative to requesting systems and a plurality of data attributes.

As previously described, the current methods of transferring and accessing large files over a network may take longer than desired and specific applications or systems may have vary quality of service (QoS) regarding the access of data. For example, a system's available bandwidth may exceed that of particular storage controller's bandwidth when that particular controller is being accessed via multiple network devices.

As such, it may be advantageous, among other things for a method to be able to accelerate the transfer and access of files by intelligently and strategically dividing and placing files across a number of storage controllers in a network-attached storage (NAS) environment, dependant on factors relative to requesting systems and a plurality of data attributes that may be stored in metadata (or a similar method of attributes) associated with a file. As such, there may be a faster access to files and a distributed workload of NAS storage controllers as well as a balancing of speed of access with resource consumption. Additionally, there may be a balancing of the storage controller component wear in a NAS environment and a balancing of the network and storage utilization in a NAS environment. Furthermore, there may also be accommodation for a system or application defined quality of service (QoS).

According to at least one embodiment of the present invention, a file access optimization program may determine which system or systems drive the inclusion of a file into cache as well as determine which storage location (i.e., storage controller) to store the file on based on the relative location of the requesting systems to storage controllers (e.g., latency, input/output (I/O), etc.) and metadata information. Additionally, the method may use attributes associated with a file (i.e., file access requirements) to determine whether to divide the file. The method may also determine the optimal number of storage controllers to store the data as well as determine which storage controllers may allow the system to meet pre-determined requirements. Then the method may divide a file accordingly and distribute the file to proper storage controllers. Additionally, the method may update a tracker-updates client and may provide the file following a request, such as a read request from a requesting system (e.g., server) over peer to peer (p2p) from the storage controllers.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java and all Java-based trademarks and logos are trademarks or registered trademarks of Oracle and/or its affiliates), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments of the present invention relate generally to the field of computing, and more particularly to file storage and transfers. The following described exemplary embodiments provide a system, method and program product to accelerate the transfer and access of files by intelligently and strategically dividing and placing files across a number of storage controllers in a network-attached storage (NAS) environment, dependant on factors relative to requesting systems and a plurality of data attributes.

According to at least one embodiment of the present invention, a file access optimization program may determine which system or systems drive the inclusion of a file into cache as well as determine where to store the file based on the relative location of the requesting systems to storage controllers (e.g., latency, input/output (I/O), etc.) and metadata information. The method may use attributes associated with a file to determine whether to divide the file. The method may also determine the optimal number of storage controllers to store the data as well as determine which storage controllers may allow the system to meet pre-determined requirements. Then the method may divide a file accordingly and distribute the file to proper storage controllers. Additionally, the method may update a tracker-updates client and to provide the file following a request, such as a read request from a system (e.g., server) over peer to peer from the storage controllers.

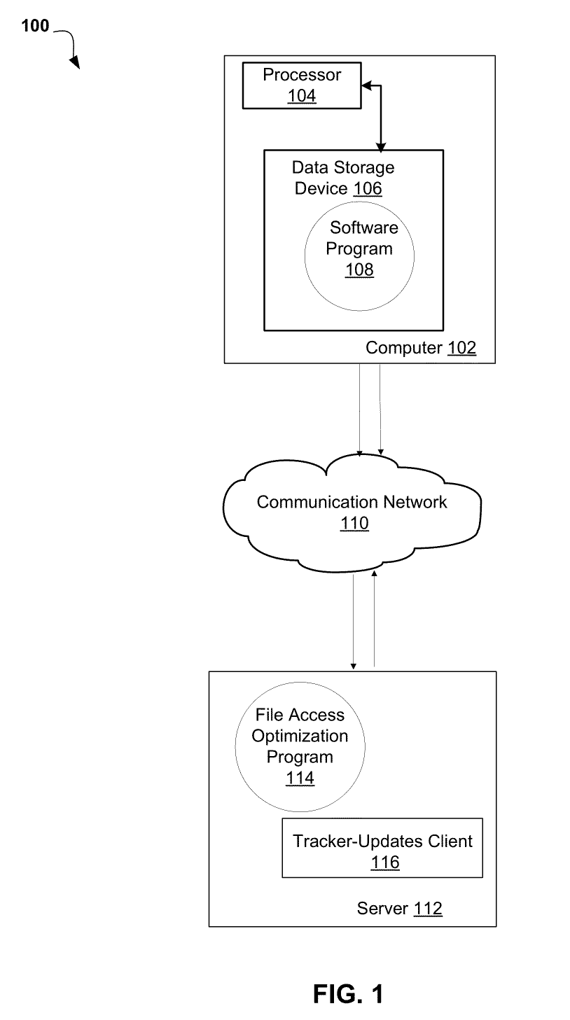

Referring to FIG. 1, a block diagram which illustrates a networked computer environment 100 in accordance with one embodiment is depicted. The networked computer environment 100 may include a computer 102 with a processor 104 and a data storage device 106 that is enabled to run a software program 108. The networked computer environment 100 may also include a server 112 that is enabled to run a file access optimization program 114. The file access optimization program 114 may interact with a tracker-updates client 116 and a communication network 110.

The networked computer environment 100 may include a plurality of computers 102 and servers 112, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

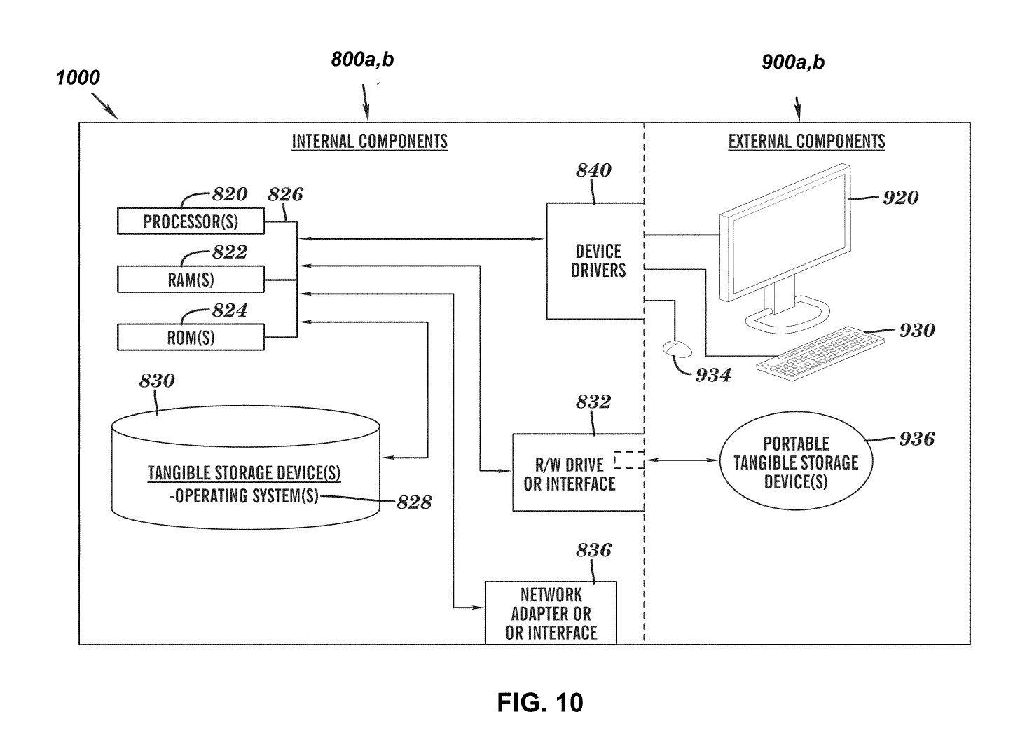

The client computer 102 may communicate with server computer 112 via the communications network 110. The communications network 110 may include connections, such as wire, wireless communication links, or fiber optic cables. As will be discussed with reference to FIG. 10, server computer 112 may include internal components 800a and external components 900a, respectively, and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing devices capable of running a program, accessing a network, and accessing a database.

As previously described, the client computer 102 may access server 112 via the communications network 110. For example, a user using an application program 108 running on a client computer 102 may create a file to be sent via the communications network 110 to a sever 112. The server 112 may then issue a command to write the file to a storage location.

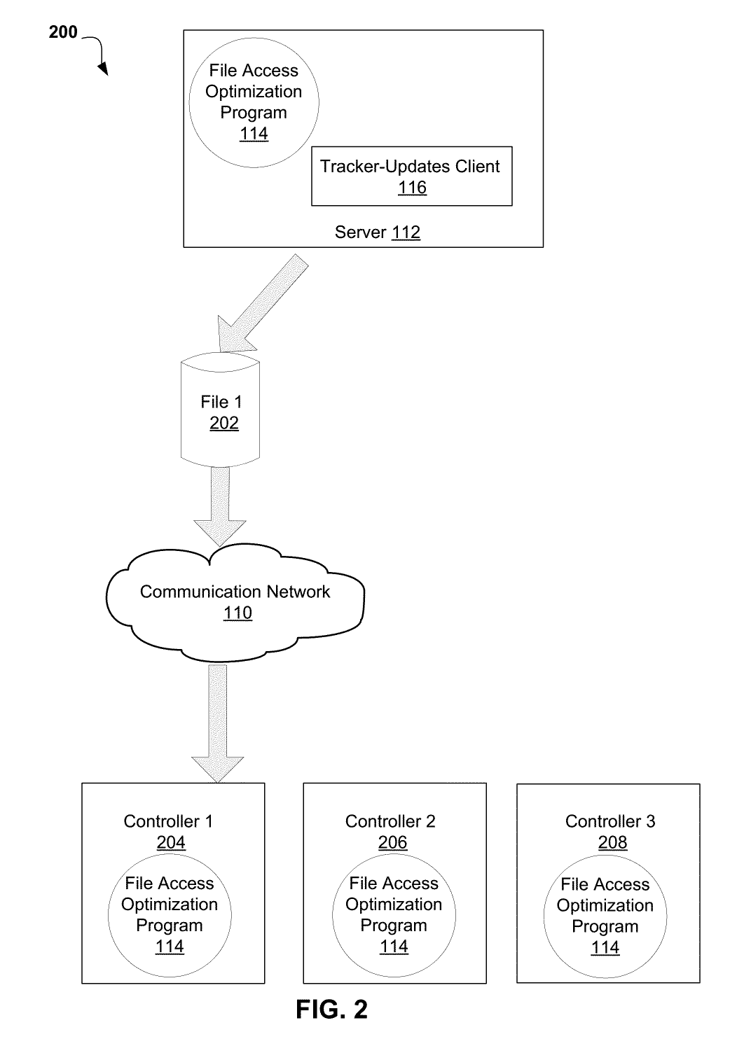

Referring now to FIG. 2, a block diagram which is illustrates a networked computer environment 200 with an exemplary file access optimization program and a tracker-updates client according to at least one embodiment is depicted. According to one embodiment, a command may be issued from a server 112 to write a file 202 to a storage location, such as a controller (i.e., storage controller) 204-208. For example, server 112, which may be running file access optimization program 114 and tracker-updates client 116 may issue a command to write a file, such as (file 1) 202 via a communications network 110 to (controller 1) 204 running file access optimization program 114 or another controller, such as (controller 2) 206 running file access optimization program 114 or (controller 3) 208 running file access optimization program 114.

As previously described, a file access optimization program 114 running on a controller 204-208 may determine which system or systems drive the inclusion of a file 202 into cache as well as determine the relative location of the requesting systems to controllers 204-208 (e.g., latency, input/output (I/O), etc.). The file access optimization program 114 may also consider metadata information associated with the file 202 in order to determine where and how to store the file 202. For example, the file access optimization program 114 may use attributes associated with the file 202 (i.e., metadata) to determine whether to divide the file 202 into multiple pieces. The file access optimization program 114 may also determine the optimal number of controllers 204-208 to store the data on as well as determine which controllers 204-208 may allow the system to meet pre-determined requirements (i.e., quality of service (QoS) requirements), such as how quickly the file 202 needs to be retrieved. For example, the file 202 may need to be retrieved in X amount of seconds. As such, the file access optimization program 114 may divide the file 202 accordingly and distribute the file 202 to proper controllers 204-208. Additionally, the file access optimization program 114 may utilize the tracker-updates client 116 to provide the file 202 over peer to peer from controllers 204-208 when the file 202 is retrieved.

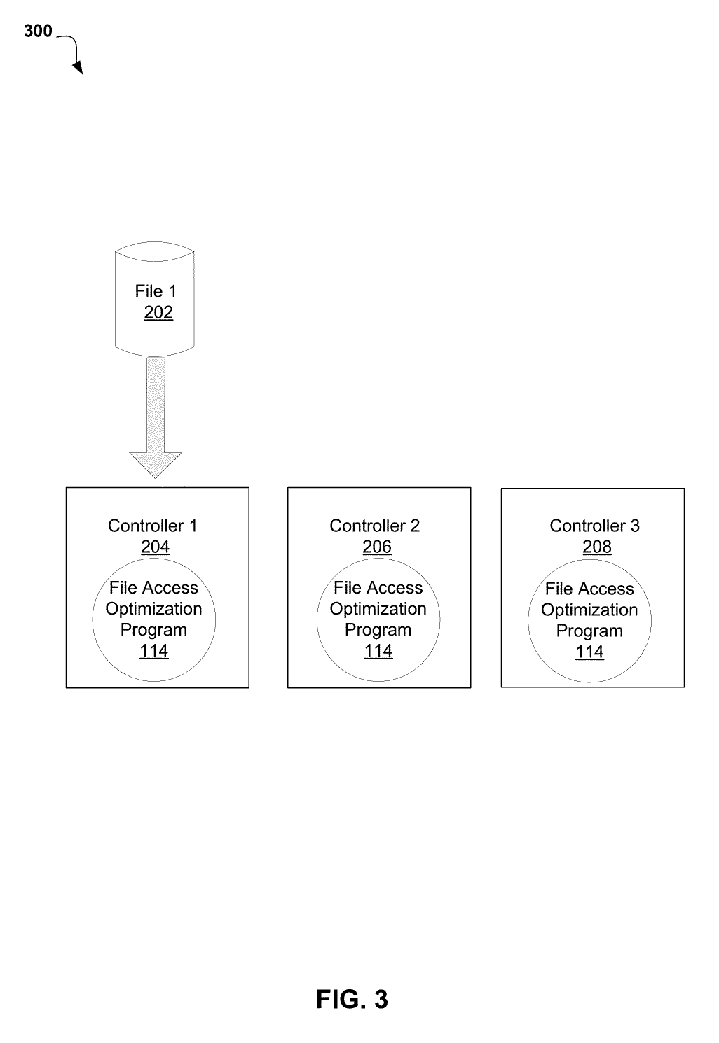

Referring now to FIG. 3, a block diagram which illustrates a networked computer environment with an exemplary file access optimization program according to at least one embodiment is depicted. As previously described, according to one embodiment, a command may be issued from a server, such as server 112 (FIG. 2) to write a file 202 to a controller 204-208 running file access optimization program. For example, a server 112 (FIG. 2) may contact a cloud storage device, such as a controller 204-208 via a communication network 110 (FIG. 2) to store a file 202. The file 202 may have metadata associated with it. The metadata may contain access requirements, such as in how many seconds the file 202 needs to be retrieved when a retrieve command for the file 202 is issued from the server 112. As such, the metadata may be utilized by the file access optimization program 114 to determine whether the file requirements exceed the capabilities of the controller 204-208. For example, the controller, 204-208 running file access optimization program 114 may access the metadata information associated with the file 202, such as the file access throughput requirements to determine which controller 204-208 to store the file on. The controller, 204-208 running file access optimization program 114 may also determine which controller 204-208 to store the file 202 on based on the relative location of requesting systems (e.g., server 112) to controllers 204, 208, such as latency, input/output (I/O), etc. For example, a network may be a 10 GB network and the file access throughput requirement for a file 202 may be 25 GB per second. As such, the controller 204 may determine how many additional controllers 206, 208 may be required to meet the file access requirements stored in the metadata associated with the file 202. For example, a controller 204 running file access optimization program 114 may determine based on the metadata associated with a file 202 that two additional controllers 206, 208 may be required to meet the file access requirements stored in the metadata associated with the file 202.

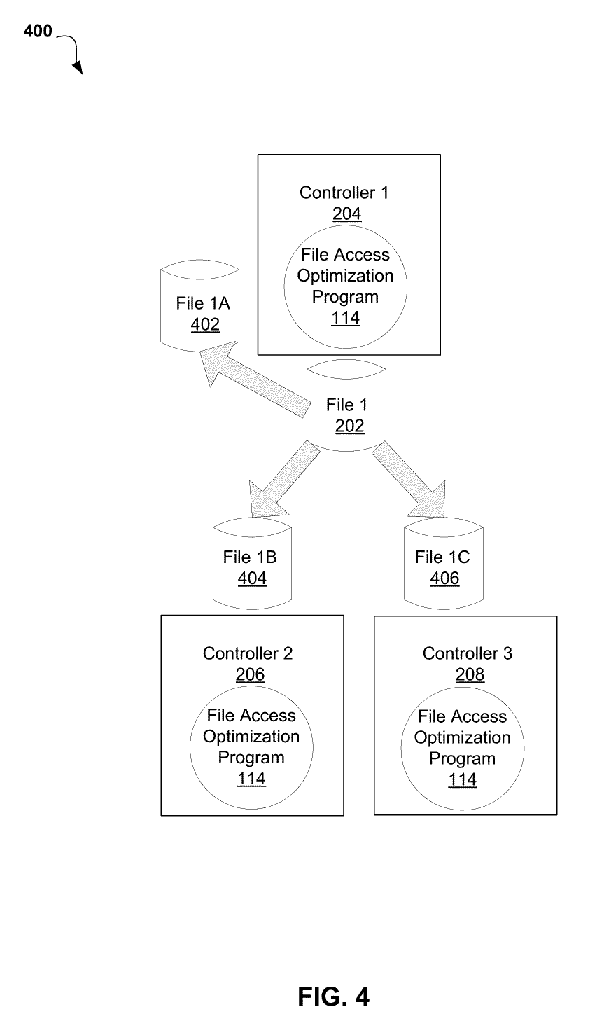

Referring now to FIG. 4, a block diagram which illustrates a networked computer environment where a file may be evenly divided and distributed to storage controllers according to at least one embodiment is depicted. As previously explained with respect to FIG. 3, the controller 204 may receive the file 202 and the file requirements (i.e., metadata). According to one implementation of the present embodiment, the controller 204 may determine using the file access optimization program 114 whether the controller 204 can meet the file requirements on its own. As such, the controller 204 may determine how many additional controllers 206, 208 may be required to meet the file access requirements stored in the metadata associated with a file 202. For example, File access optimization program 114 running on (controller 1) 204 may determine based on the file access requirements stored in the metadata associated with a file 202 that the file 202 needs to be divided among three controllers, such as (controller 1) 204, (controller 2) 206, and (controller 3) 208 to meet the file access requirements stored in the metadata associated with a file 202. For example purposes only with respect to FIG. 4, the (file 1) 202 may be divided into three evenly distributed files, such as (file 1A) 402, (file 1B) 404, and (file 1C) 406.

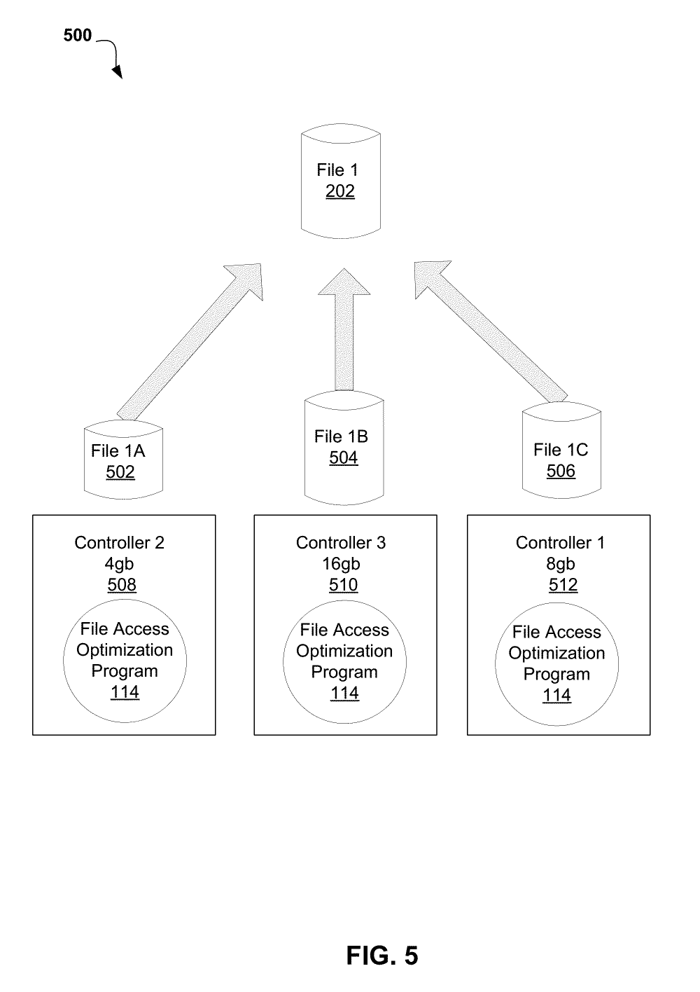

Referring now to FIG. 5, a block diagram which illustrates a networked computer environment where a file may be disproportionately divided and distributed to storage controllers based on the capabilities of the storage controllers according to at least one embodiment is depicted. As previously described, file access optimization program 114 running on (controller 1) 512 may determine based on the file access requirements stored in the metadata associated with a (file 1) 202 that the (file 1) 202 needs to be divided among three controllers 508-512, such as (controller 1) 512, (controller 2 508), and (controller 3) 510 to meet the file access requirements stored in the metadata associated with a file 202. However, according to one implementation of the present embodiment, the (controller 1) 512 running file access optimization program 114 may determine that the (file 1) 202 may be divided disproportionately (as opposed to being divided evenly as depicted with respect to FIG. 4) according to the file 202 requirements stored in the metadata associated with the (file 1)202 and based on the capabilities of the controller 508-512, such as how fast the server 114 (FIG. 2) may be able to retrieve the portion 502-506 of the file 202 from the storage controller 508-512 following a request, such as a read request from the server 114 (FIG. 2). For example, with respect to FIG. 5, (file 1) 202 may be partitioned according to the transfer speed to the server 112 (i.e., the requester 112) where all devices (e.g., controllers 508-512) communicate through a 16 GB switch, As such the limitation in this example, would be the device 508-512. Therefore, smaller segments of the (file 1) 202 may be stored on controllers 508-512 that are further away or slower. For example, (controller 2) 508 may be a 4 GB fiber channel device; (controller 3) 510 may be a 16 GB fiber channel device; and (controller 1) 512 may be an 8 GB fiber channel device. As such, a larger portion of (file 1) 202, such as (file 1B) 504 may be stored on the faster (controller 3) 510 16 GB fiber channel. Similarly, a smaller portion of (file 1) 202, such as (file 1A) 502 may be stored on the slowest (controller 2) 508 (4 GB fiber channel) and a medium size portion of (file 1) 202, such as (file 1C) 506 may be stored on the medium speed (controller 1) 512 (8 GB fiber channel).

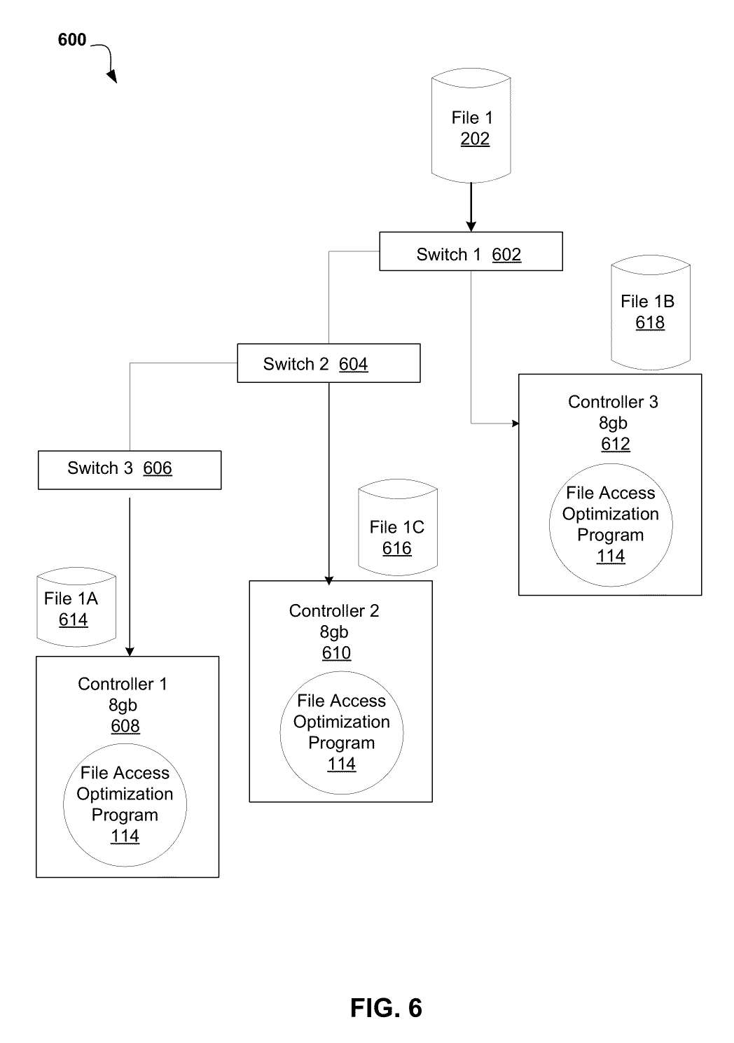

Referring now to FIG. 6, a block diagram which illustrates a networked computer environment where a file may be disproportionately divided and distributed to storage controllers based on the hops of the storage controllers according to at least one embodiment is depicted. As previously described, file access optimization program 114 running on (controller 1) 608 may determine based on the file access requirements stored in the metadata associated with a file, such as (file 1) 202 that the file 202 needs to be divided among three controllers, such as (controller 1) 608, (controller 2) 610, and (controller 3) 612 to meet the file access requirements stored in the metadata associated with a file 202. However, according to one implementation of the present embodiment, the (controller 1) 608 running file access optimization program 114 may determine that the (file 1) 202 may be divided disproportionately according to the file requirements stored in the metadata associated with the (file 1) 202. As such, with respect to FIG. 6, (file 1) 202 may be partitioned according to the latency or hops of the storage controllers 608-612 being used since all the controllers 608-612 being used may have the same capabilities. A hop represents one portion of the path between a source and a destination. Therefore, it may take a data packet longer to travel through multiple intermediate devices, such as switches than to travel over a single wire to reach a destination. For example, server 114 (FIG. 2) may be operating on (switch 1) 602 and server 114 (FIG. 2) may make a request for a file portion, such as (file 1A) 614 stored on (controller 1) 608, (file 1B) 618 stored on (controller 3) 612, or (file 1C) 616 stored on (controller 2) 610. Since (controller 1) 608 has to pass through (switch 3) 606; (switch 3) 606 has to pass through (switch 2) 604; and (switch 2) 604 has to pass through (switch 1) before the server 114 (FIG. 2) can access the (controller 1) 608, it may take longer for the server 114 (FIG. 2) to access (controller 1) 608 than for the server 114 (FIG. 2) to access (controller 3) 612 which may be operating on the same (switch 1) 602 as the server 114 (FIG. 2). Therefore, as depicted in FIG. 6, the (file 1) 202 may be divided into different sizes according to the hops of the storage controller 608-612.

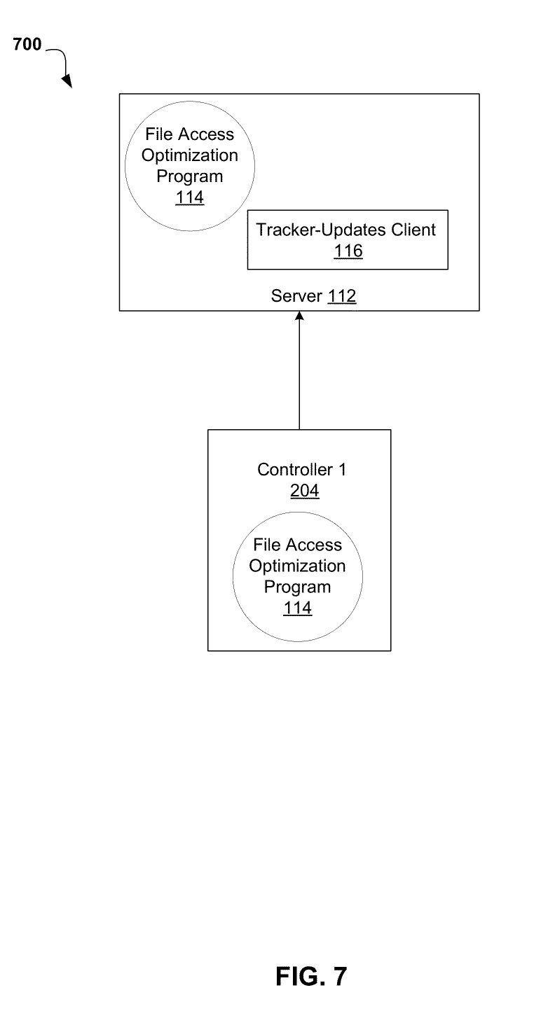

Referring now to FIG. 7, a block diagram illustrating a server with an exemplary tracker-updates client according to at least one embodiment is depicted. According to one implementation of the present embodiment, the (controller 1) 204 may update a tracker-updates client 116 running on the server 112 after the (controller 1) 204 has determined (via the file access optimization program 114) the placement and distributed portions 402-406 (FIG. 4) of the (file 1) 202 (FIG. 4). For example, the (controller 1) 204 may update tracker-updates client 116 running on the server 112 regarding (file 1A) 402 (FIG. 4) being stored on (controller 1) 204; regarding (file 1B) 404 (FIG. 4) being stored on (controller 2) 206; and regarding (file 1C) 406 (FIG. 4) being stored on (controller 3) 208.

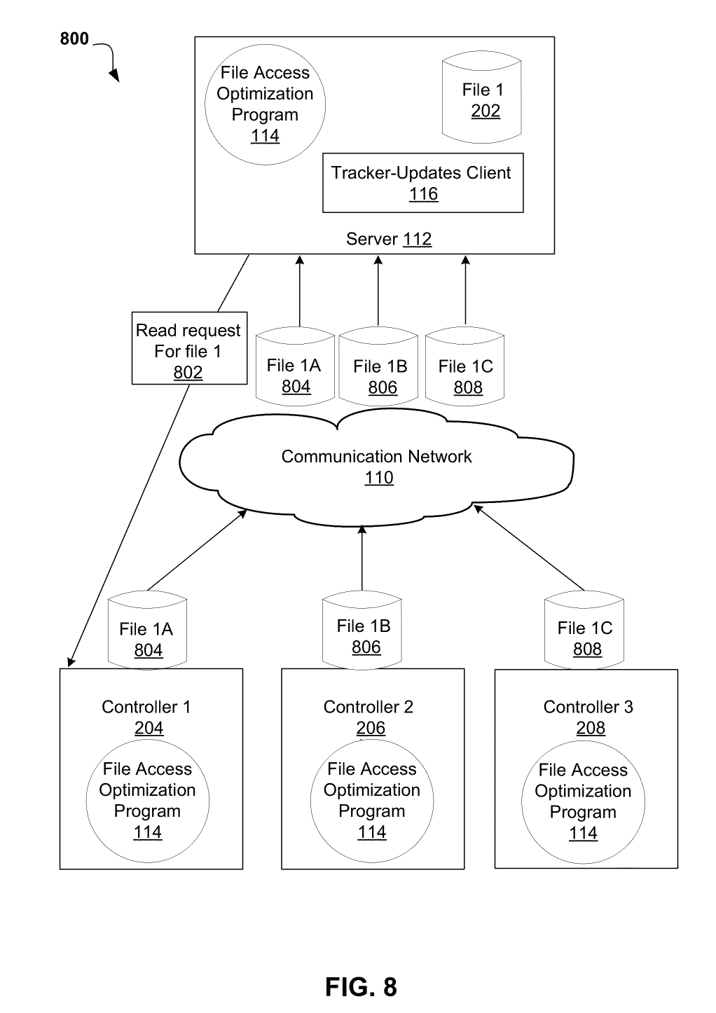

Referring now to FIG. 8, a block diagram which illustrates a networked computer environment where the stored portions of a divided file may be retrieved and reconstructed from the storage controllers according to at least one embodiment is depicted. For example, according to one embodiment, a server 112 running tracker-updates client 116 may send a read request 802 for (file 1) 202 to the appropriate controllers 204-208 running file access optimization program 114. Then the controllers 204-208 may send their respective segments (i.e., portions) of (file 1) 202, such as (file 1A) 802, (file 1B) 806, and (file 1C) 808 via the communication network 110 to server 112. Server 112 may then utilize the portions 802-808 of (file 1) 202 to reconstruct the (file 1) 202 and make the (file 1) 202 a whole file 202.

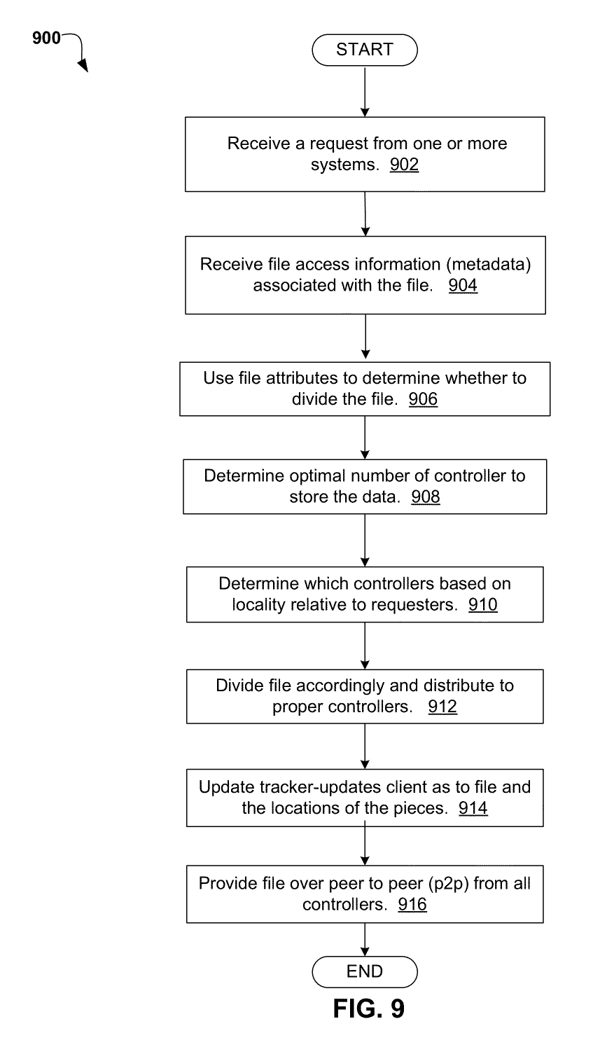

Referring now to FIG. 9, an operational flowchart illustrating the steps carried out by a file access optimization program according to at least one embodiment is depicted. As previously described, a file access optimization program 114 (FIG. 2) running on a controller 204-208 (FIG. 2) may determine which system or systems drive the inclusion of a file 202 (FIG. 2) into cache as well as determine the relative location of the requesting systems to controllers 204-208 (FIG. 2) (e.g., latency, input/output (I/O), etc.). The file access optimization program 114 (FIG. 2) may also consider metadata information associated with the file in order to determine where and how to store the file.

At 902, a storage controller may receive a request (i.e., a file transfer request associated with a file), such as a write request from one or more systems. For example, a (controller 1) 204 (FIG. 2), such as a cloud controller or other technology may receive a write request to store a file 202 (FIG. 2) from server 112 (FIG. 2) via a communication network 110 (FIG. 2).

Next at 904, the controller may acquire for the file transfer request, a plurality of service level objectives associated with the file. The plurality of service level objectives associated with the file may comprise of at least one of a quality of service metrics associated with the file transfer request and a plurality of stored information pertaining to a source associated with the file transfer request. Furthermore, the quality of service metrics associated with the file transfer request and the plurality of stored information pertaining to the source associated with the file transfer request may comprise of the following: a determination as to split the file; a determination as to a size of the file relative to a cache on at least one storage component; a determination as to a temperature (e.g., hotness) of a plurality of data; a determination as to a time to access the file; a determination as to an importance of the file; and a determination as to a plurality of systems regularly using the file.

As such the controller may receive file access information (i.e., metadata), such as QoS factors or other file access requirements associated with the file. The controller may also receive some of the relative network parameters from the server (i.e., a capability of a device or a capability of an infrastructure), such as the number of hops, the latency, the speed of input/output (I/O) operations, or the bandwidth that the server can receive a file from. According to one implementation of the present embodiment, the controller may determine metadata QoS requirements and store such information themselves. According to another implementation, an administrator or application may determine metadata QoS requirements. For example, an administrator may set metadata QoS requirements to intentionally skew results or to avoid tests. Additionally, according to at least one implementation, the metadata QoS requirements may drive which controller to initially contact for storage.

Then at 906, the controller may use the file attributes to determine whether to divide the file (i.e., the file-distribution). The file-distribution comprises a determination as to whether to divide the file into a plurality of segments based on the plurality of file access information. As such, the controller may use the requirements from the server on accessing the file along with the known network information, such as the number of hops, the total bandwidth available, average utilization, and various other parameters to determine a file-distribution. The controller may also use the requirements from the server on accessing the file along with the known network information to determine whether or not the controller may be able to service the requirements by itself or whether the controller may need help from other storage controllers to service the request. According to at least one implementation, file attributes may be used to determine whether to split (i.e., divide) the file; to determine the size of the file relative to the cache on controllers; to determine temperature of the data; to determine the number of systems regularly using the file; to determine an expected or desired time to access the file; and to determine the importance of the file. Furthermore, when the system writes the file to a controller, it may include the requirements in the metadata regarding the access attributes. The access attributes may be speed related such as latency, I/O, etc. The file metadata may be set by an administrator or included by the software in the server by means of an application writing and reading the file.

At 908, the controller may determine the file-distribution storage location which includes determining the optimal number of controllers needed to store the data as well as which other controllers should be utilized based upon the parameters of the other controllers. For example, if all the controllers 204-208 (FIG. 2) are able to service a file quickly, then fewer controllers may be needed to store the data as opposed to controllers that have lower throughput rates or higher number of hops.

Next at 910, the file-distribution storage location may further be determined by the controller determining which controllers to utilize based on the controller's locality relative to the requester's locality. According to one implementation, the controller may consider the latency, bandwidth, number of hops, etc. of the storage controllers 204-208 (FIG. 2). Additionally, according to one implementation, the speed of the controller in a heterogeneous environment may be taken into consideration. For example, there may be several types of controllers 502-506 (FIG. 5) with different capabilities, such as available storage space.

Then at 912, the controller may divide the file accordingly and distribute the file to the proper controllers. The distributing of the file to the proper controllers may include distributing a plurality of file segments associated with the file to at least one storage component associated with a shared storage infrastructure, wherein the distributing is based on a determining of at least one resource capability associated with the at least one storage component. As such, the resource capability associated with the at least one storage component may comprise of at least one of a plurality of network parameters, a plurality of throughput information, a plurality of utilization information, and a plurality of efficiency information.

Furthermore, the distributing of the plurality of file segments associated with the file to at least one storage component may comprise of the following: determining a location for a source of the at least one file transfer request; determining a location of at least one available storage component associated with the shared storage infrastructure; and allocating the plurality of file segments associated with the file to at least one storage location, wherein the allocating is based on satisfying the plurality of service level objectives associated with the file.

For example, according to one implementation, the controller may determine the segment and size variances to divide the file into. As such, the size may vary for each controller 502-506 (FIG. 5) and may be determined by the capabilities relative to the other controllers being utilized. Additionally, according to another implementation, the division of a file may occur immediately or may be postponed until the controller(s) have enough free dynamic random-access memory (DRAM) and input/output (I/O) to execute.

At 914, the controller may update the tracker update client as to information pertaining to the file and the locations of the pieces. As such, a tracker-updates client may be updated based the distributing of the plurality of file segments associated with the file optimally to at least one storage component. For example, after the controller 204 (FIG. 7) has determined the placement and the distributed portions of the file, the controller 204 (FIG. 7) may update a tracker-updates client 116 (FIG. 7) with such information so the file may be downloaded simultaneously upon request.

Then at 916, the controller may provide the file over peer to peer (p2p) from all controllers. This may include the directing of a complete transfer of the plurality of file segments associated with the file from the at least one storage component based on a file request for the file. For example, the controller 204 (FIG. 8) may engage a file transfer over p2p based on the information contained in the tracker-updates client 116 (FIG. 8) pertaining to a file 202 (FIG. 8) when a request, such as a read request 802 (FIG. 8) for the file 202 (FIG. 8) is received by a server 112 (FIG. 8). Furthermore, a transfer rate may be recorded for at least one segment in the plurality of file segments from a respective storage component, wherein the transfer rate is in response to at least one service level objective for maintaining a target rate of transfer in a specific period of time.

Furthermore, according to at least one embodiment of the present invention, optimizing a file transfer may be implemented by a processor may receiving at least one file transfer request associated with a file. Then the processor may acquire, for the at least one file transfer request, a plurality of service level objectives associated with the file. Next, the processor may distribute a plurality of file segments associated with the file optimally to at least one storage component associated with a shared storage infrastructure, wherein the distributing is based on a determining of at least one resource capability associated with the at least one storage component. Then the processor may direct a complete transfer of the plurality of file segments associated with the file from the at least one storage component based on a file request for the file.

Also included in at least one implementation may be the recording of a transfer rate for at least one segment in the plurality of file segments from a respective storage component, wherein the transfer rate is in response to at least one service level objective for maintaining a target rate of transfer in a specific period of time. Additionally, the plurality of service level objectives associated with the file may comprise of at least one of a quality of service metrics associated with the file transfer request and a plurality of stored information pertaining to a source associated with the file transfer request. Furthermore, the distributing of the plurality of file segments associated with the file optimally to at least one storage component may comprise of the following: a determining a location for a source of the at least one file transfer request; a determining a location of at least one available storage component associated with the shared storage infrastructure; and allocating the plurality of file segments associated with the file to at least one storage location, wherein the allocating is based on satisfying the plurality of service level objectives associated with the file.

Additionally, the method may include that the at least one resource capability associated with the at least one storage component comprises at least one of a plurality of network parameters, a plurality of throughput information, a plurality of utilization information, and a plurality of efficiency information. Furthermore, the method may include the updating of a tracker-updates client based the distributing of the plurality of file segments associated with the file optimally to at least one storage component. The method may also include that the quality of service metrics associated with the file transfer request and the plurality of stored information pertaining to the source associated with the file transfer request comprises at least one of the following: a determination as to split the file; a determination as to a size of the file relative to a cache on at least one storage component; a determination as to a temperature of a plurality of data; a determination as to a time to access the file; a determination as to an importance of the file; and a determination as to a plurality of systems regularly using the file.

Referring now to FIG. 10, a block diagram of internal and external components of computers depicted in FIG. 1 in accordance with an illustrative embodiment of the present invention. It should be appreciated that FIG. 10 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server computer 112 (FIG. 1) include respective sets of internal components 800 a, b and external components 900 a, b illustrated in FIG. 10. Each of the sets of internal components 800 a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and software program 108 (FIG. 1) in client computer 102 are stored on one or more of the respective computer-readable tangible storage devices 830 for execution by one or more of the respective processors 820 via one or more of the respective RAMs 822 (which typically include cache memory). In the embodiment illustrated in FIG. 10, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program 108 can be stored on one or more of the respective portable computer-readable tangible storage devices 936, read via the respective R/W drive or interface 832 and loaded into the respective hard drive 830.

Each set of internal components 800 a, b also includes network adapters or interfaces 836 such as a TCP/IP adapter cards, wireless wi-fi interface cards, or 3G or 4G wireless interface cards or other wired or wireless communication links. A software program 108 in client computer 102 can be downloaded to client computer 102 from an external computer via a network (for example, the Internet, a local area network or other, wide area network) and respective network adapters or interfaces 836. From the network adapters or interfaces 836, the software program 108 in client computer 102 is loaded into the respective hard drive 830. The network may comprise copper wires, optical fibers, wireless transmission, routers, firewalls, switches, gateway computers and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for optimizing a file transfer, the method comprising:
receiving at least one file transfer request associated with a file;
acquiring, for the at least one file transfer request, a plurality of service level objectives associated with the file;
distributing a plurality of file segments associated with the file to at least one storage component associated with a shared storage infrastructure, wherein the distributing is based on a determining of at least one resource capability associated with the at least one storage component; and
directing a complete transfer of the plurality of file segments associated with the file from the at least one storage component based on a file request for the file.

2. The method of claim 1, further comprising:
recording a transfer rate for at least one segment in the plurality of file segments from a respective storage component, wherein the transfer rate is in response to at least one service level objective for maintaining a target rate of transfer in a specific period of time.

3. The method of claim 1, wherein the plurality of service level objectives associated with the file comprises at least one of a quality of service metrics associated with the file transfer request and a plurality of stored information pertaining to a source associated with the file transfer request.

4. The method of claim 1, wherein the distributing the plurality of file segments associated with the file to at least one storage component comprises:
determining a location for a source of the at least one file transfer request;
determining a location of at least one available storage component associated with the shared storage infrastructure; and
allocating the plurality of file segments associated with the file to at least one storage location, wherein the allocating is based on satisfying the plurality of service level objectives associated with the file.

5. The method of claim 1, wherein the at least one resource capability associated with the at least one storage component comprises at least one of a plurality of network parameters, a plurality of throughput information, a plurality of utilization information, and a plurality of efficiency information.

6. The method of claim 1, further comprising:
updating a tracker-updates client based the distributing of the plurality of file segments associated with the file to at least one storage component.

7. The method of claim 3, wherein the quality of service metrics associated with the file transfer request and the plurality of stored information pertaining to the source associated with the file transfer request comprises at least one of a determination as to split the file; a determination as to a size of the file relative to a cache on at least one storage component; a determination as to a temperature of a plurality of data; a determination as to a time to access the file; a determination as to an importance of the file; and a determination as to a plurality of systems regularly using the file.

8. A computer system for optimizing a file transfer, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving at least one file transfer request associated with a file;
acquiring, for the at least one file transfer request, a plurality of service level objectives associated with the file;
distributing a plurality of file segments associated with the file to at least one storage component associated with a shared storage infrastructure, wherein the distributing is based on a determining of at least one resource capability associated with the at least one storage component; and
directing a complete transfer of the plurality of file segments associated with the file from the at least one storage component based on a file request for the file.

9. The computer system of claim 8, further comprising:
recording a transfer rate for at least one segment in the plurality of file segments from a respective storage component, wherein the transfer rate is in response to at least one service level objective for maintaining a target rate of transfer in a specific period of time.

10. The computer system of claim 8, wherein the plurality of service level objectives Associated with the file comprises at least one of a quality of service metrics associated with the file transfer request and a plurality of stored information pertaining to a source associated with the file transfer request.

11. The computer system of claim 8, wherein the distributing the plurality of file segments associated with the file to at least one storage component comprises:
determining a location for a source of the at least one file transfer request;
determining a location of at least one available storage component associated with the shared storage infrastructure; and
allocating the plurality of file segments associated with the file to at least one storage location, wherein the allocating is based on satisfying the plurality of service level objectives associated with the file.

12. The computer system of claim 8, wherein the at least one resource capability associated with the at least one storage component comprises at least one of a plurality of network parameters, a plurality of throughput information, a plurality of utilization information, and a plurality of efficiency information.

13. The computer system of claim 8, further comprising:
updating a tracker-updates client based the distributing of the plurality of file segments associated with the file to at least one storage component.

14. The computer system of claim 10, wherein the quality of service metrics associated with the file transfer request and the plurality of stored information pertaining to the source associated with the file transfer request comprises at least one of a determination as to split the file; a determination as to a size of the file relative to a cache on at least one storage component; a determination as to a temperature of a plurality of data; a determination as to a time to access the file; a determination as to an importance of the file; and a determination as to a plurality of systems regularly using the file.

15. A computer program product for optimizing a file transfer, the computer program product comprising:
one or more computer-readable storage devices and program instructions stored on at least one of the one or more tangible storage devices, the program instructions executable by a processor, the program instructions comprising:
program instructions to receive at least one file transfer request associated with a file;
program instructions to acquire, for the at least one file transfer request, a plurality of service level objectives associated with the file;
program instructions to distribute a plurality of file segments associated with the file to at least one storage component associated with a shared storage infrastructure, wherein the distributing is based on a determining of at least one resource capability associated with the at least one storage component; and
program instructions to direct a complete transfer of the plurality of file segments associated with the file from the at least one storage component based on a file request for the file.

16. The program product of claim 15, further comprising:
recording a transfer rate for at least one segment in the plurality of file segments from a respective storage component, wherein the transfer rate is in response to at least one service level objective for maintaining a target rate of transfer in a specific period of time.

17. The program product of claim 15, wherein the plurality of service level objectives associated with the file comprises at least one of a quality of service metrics associated with the file transfer request and a plurality of stored information pertaining to a source associated with the file transfer request.

18. The program product of claim 15, wherein the distributing the plurality of file segments associated with the file to at least one storage component comprises:
determining a location for a source of the at least one file transfer request;
determining a location of at least one available storage component associated with the shared storage infrastructure; and
allocating the plurality of file segments associated with the file to at least one storage location, wherein the allocating is based on satisfying the plurality of service level objectives associated with the file.

19. The program product of claim 15, wherein the at least one resource capability associated with the at least one storage component comprises at least one of a plurality of network parameters, a plurality of throughput information, a plurality of utilization information, and a plurality of efficiency information.

20. The program product of claim 15, further comprising:
updating a tracker-updates client based the distributing of the plurality of file segments associated with the file to at least one storage component.
